(19) United States
(12) Patent Application Publication
(10) Pub. No.: US 2008/0226011 A1
(43) Pub. Date: Sep. 18, 2008

(54) Plasma Centrifuge Heat Engine Beam Fusion Reactor

(76) Inventor: Daniel C. Barnes, (US)

Correspondence Address: DANIEL C BARNES, 146 BISHOP LAMY RD., LAMY, NM, 87540, US

(21) Appl. No.: 11/534,171

(22) Filed: Sep. 21, 2006

Related U.S. Application Data
(60) Provisional application No. 60/596,567, filed on Oct. 4, 2005.
(60) Provisional application No. 60/766,791, filed on Feb. 12, 2006.

(51) Int. Cl. G21B 1/03

(52) U.S. Cl. 376/107; 376/142

(57) ABSTRACT

A system and apparatus for a magnetized plasma nuclear fusion reactor, incorporating special design features which induce a plasma heat engine cycle in a rapidly rotating plasma. The heat engine operates either continuously or by oscillations. A continuous heat engine is formed in the open field outside a field reversed configuration. The oscillatory system operates in synchronism with cyclic acceleration, collision, and deceleration of plasma masses to produce nuclear fusion reactions at an economically useful rate with a relatively small driving power required. A special magnetic field design is combined with applied electrical voltages at the end of the field lines to produce required conditions. Design features allow recovery of large fraction of collision heat which would otherwise be dissipated as a parasitic loss.

### CROSS-REFERENCE TO RELATED APPLICATIONS

This application is a continuation of provisional application 60/596,567, “Plasma Centrifuge Heat Engine for Colliding Beam Fusion Applications”, filed Oct. 4, 2005 and provisional application 60/766,791, “Plasma Centrifuge Heat Engine for Continuous Beam Fusion Reactor”, filed Feb. 12, 2006, which applications are fully incorporated herein by reference.

### BACKGROUND OF THE INVENTION

### Field

This invention is in the fields of plasma physics and energy supply and provides a new basis for operation of nuclear fusion reactor systems.

Nuclear fusion is a process which can produce virtually unlimited energy from plentiful and inexpensive fuel. For example, the fusion yield of a single gram (about the mass of a postage stamp) of deuterium-tritium (isotopes of hydrogen which are easily and inexpensively obtained) mixed in equal proportions is about 352 giga-Joules of energy, the energy equivalent of over 3000 gallons of gasoline. On the other hand, known processes for the release of fusion energy require extreme conditions. For deuterium-tritium, the fusion fuel cycle “easiest” to cause to release energy in a thermonuclear system, a temperature of over 100,000,000 degrees Kelvin (almost 8 times the temperature of the center of our sun) is required to give individual particles sufficient thermal energy to cause fusion to occur at an economically interesting rate. The containment of such extreme temperatures at practical pressures, and with sufficient quality of confinement has posed a challenge for more than the past ½ century. Presently, six of the world's leading economic powers are planning a very large project to achieve necessary conditions in the ITER large tokamak.

The difficulty of achieving these necessary conditions has led to the investigation of various alternative methods of causing fusion energy release. Many past schemes have focused on the use of beams of particles which may strike a target made of fusion fuel. In this case, the beam energy is sufficiently high to cause fusion energy to be released. The two main advantages of beam-target fusion systems are reduced temperature requirements and increased reactivity. Required temperature is reduced, since only a minority of particles (those in the beam) are required to have a large enough energy to cause fusion reactions. Reactivity is increased by optimizing the beam energy for peak reactivity.

These advantages also make practical the use of “advanced” or “aneutronic” fuel cycles which release fusion energy only in the form of electrically charged particles and avoid the copious energetic neutron production of deuterium-tritium fusion. For example, deuterium may fuse with the isotope of Helium having atomic mass 3 or ordinary Hydrogen (protons) may fuse with the isotope of Boron with atomic mass 11 to release fusion energy entirely in the form of charged particles. These charged fusion products are magnetically confined from striking material structures until their energy has been extracted by slowing or by direct conversion.

Such fusion systems have enormous advantages over deuterium-tritium systems because of the absence of energetic neutron production. Special materials required to withstand the neutron release are not required, and nuclear activation of the surrounding structure does not occur, so that no radioactive waste is produced. Additionally, an aneutronic fusion system may be engineered so that it can not withstand energetic neutrons. In this way, nuclear proliferation concerns are completely eliminated. Besides these enormous economic and social benefits of the operation of aneutronic fusion systems, their development costs will be greatly reduced, as no shielding or special nuclear site arrangements are required.

The conditions for thermonuclear operation of aneutronic fusion cycles are known, and require increased temperatures, compared with deuterium-tritium systems. The increased temperature implies reduced density at the same pressure achieved, leading to very low reactivity and associated power density. A combination of all these factors implies that a thermonuclear proton-Boron-11 system, if it could work at all, would have a volume of about 1000 times the present deuterium-tritium tokamak systems, rendering such an embodiment impractically expensive and complex. On the other hand, beam-target approaches to proton-Boron-11 fusion can reduce the required size and complexity to be comparable with thermonuclear deuterium-tritium tokamak designs. A conclusion is that aneutronic operation may be practical only if a practical beam-target embodiment is demonstrated.

A number of previous patents have disclosed various embodiments of beam-target fusion systems, including the variant in which the target is formed by a second beam of particles. For example, in U.S. Pat. Nos. 3,258,402, and 3,386,883 Farnsworth and in U.S. Pat. Nos. 3,530,036, and 3,530,497 Hirsch disclose various embodiments for accelerating ions by electrostatic fields and causing collisions of said ions (so called Inertial Electrostatic Confinement), producing fusion reactions. In U.S. Pat. No. 4,894,199, Rostoker discloses means for forming circulating beams of ions in a tokamak as a means of avoiding transport difficulties. These ideas have been extended to the field-reversed configuration [M. Tuszewski, 28 Nuclear Fusion 2033 (1988)] in U.S. Pat. Nos. 6,888,907 to Monkhorst, et al., 6,891,911 to Rostoker, et al., and 6,894,446 to Monkhorst, et al.

All of these past schemes for beam-target fusion have suffered from the difficulty of parasitic loss of beam energy to target heating. Such heating is unavoidable and limits the usefulness of the fusion energy which may be released by beam-target interactions. Unless the target conditions are nearly sufficient for thermonuclear fusion, target heating exceeds fusion energy production by a factor of several times to several 10 times. None of the past beam-target fusion schemes has incorporated a means to overcome this fundamental limitation. Instead, focus has been placed on maximizing the capture of fusion energy release, for example by the use of direct conversion of charged particle energy to electricity. Such a strategy leads to great challenges for the economic success of such approaches and has limited their economic attractiveness, leaving the thermonuclear approach as the front runner to receive an ever growing proportion of development resources.

In U.S. Pat. No. 4,639,348 Jarnagin discloses a means for recirculation of beam energy using external devices. Such schemes, which are closely related to Inertial Electrostatic Confinement suffer from inherent inefficiencies of beam recapture and reacceleration using external apparatus. These issues have been discussed by Rider [Rider, T. H., 2 Phys. Plasmas 2853 (1995); Rider, T. H., 4 Phys. Plamsas 1039 (1997)] who pointed out that the fundamental limitations for beam-target fusion are associated with entropy production and that this can be very small for a high temperature target, but gave no means for application of this observation. Barnes and Nebel [Barnes, D. C. et al., 5 Phys. Plasmas 2498 (1998); Nebel, R. A. et al., 34 Fusion Technology 28 (1998)] discussed means to avoid these difficulties using oscillating Inertial Electrostatic Confinement systems, but did not extend these concepts further, for example to the dense, electrically neutral plasmas of the present invention.

The present invention eliminates this difficulty of beam-target fusion, while retaining the aforementioned significant advantages. Accordingly, one finds, in comparison to a thermonuclear tokamak system, a very compact and low-cost embodiment to be required for fusion conditions to be achieved. The present invention capitalizes on the extreme temperature of any plasma. For example, a simple electrical discharge in low-pressure hydrogen can easily produce a temperature of over 100,000 degrees Kelvin. Thermodynamic theory then reveals that it is possible to operate a heat engine between these extreme plasma temperatures and a near room temperature heat sink at say 500 degrees Kelvin with extremely high efficiency. For the aforementioned temperatures, the theoretical efficiency could be 0.995 so that all but 0.005 of the thermal energy of the plasma could be converted to mechanical energy. If this mechanical energy is then subsequently used to form the required beam with high efficiency, the external power systems which sustain the plasma need only replace a small fraction of the beam drag heating power which was considered previously. From the standpoint of engineering the remaining power systems, the effective fusion energy gain has been increased from a fractional value to a value which is sufficient for economic success of the overall scheme.

The present invention utilizes the mechanical energy of a rapidly rotating plasma as an intermediate energy reservoir to couple plasma heat to beam energy. Rapidly rotating plasmas have been studied at both Novosibirsk, Siberia [Abdrashitov, G. F., 7 Nucl. Fusion 1275 (1991)] and at the U. of Maryland [Ellis, R. F., 12 Phys. Plasmas 55704 (2005)] and are known to provide both stability and confinement to plasma particles.

### BRIEF SUMMARY OF THE INVENTION

The invention is various embodiments of magnetically confined plasma systems which convert a large portion of plasma thermal energy to mechanical energy. This mechanical energy is then directly reconverted to produce a beam of energetic particles. Beam particles collide with the remaining plasma to produce nuclear fusion reactions and release of energy. Plasma heating from beam slowing also occurs, but this thermal energy is converted with nearly 100% efficiency back to beam energy. From the standpoint of external power systems, only the small loss of thermal energy associated with the deficiency of the efficiency from 100% needs to be replaced. Some designs can supply this power by the confinement of fusion products which slow to heat the plasma. In this case, the external power system may actually extract electricity directly from the plasma.

In comparison with thermonuclear fusion systems, required plasma temperature is reduced by over a factor of 10. For the same confined pressure, this leads to an increase in density by over a factor of 10 and an increase in power density by over a factor of 100. Increased reactivity also accrues from operation at an optimal beam energy. These combined advantages reduce the required volume of the fusion reactor by about 1000 times. Deuterium-tritium systems become very compact and inexpensive, in comparison with thermonuclear systems. Proton-Boron-11 systems become competitive with deuterium-tritium thermonuclear systems in size and power density, offering the large advantages of operation of a fusion reactor without neutron production.

All embodiments share these common features: 1) a plasma is formed in an evacuated chamber and confined by a magnetic field generated by a combination of external coils and plasma currents; 2) the magnetic configuration is static and nearly or exactly symmetric with respect to rotation about an axis of cylindrical symmetry; 3) the magnetic field lies within planes which contain this axis, forming “closed” or “open” field lines, which lines of force are tangent to the direction of the magnetic field; 4) plasma confined on these closed and open field lines is caused to rotate by a combination of applied electrical potentials and the conversion of plasma heat to rotation; 5) a key feature is the aforesaid region of open field lines which surround any closed field line region and connect from the structure at one end to that at the opposite end of the machine, and the variation of the radius (distance from the axis) of said open field lines along their length; 6) said radius increases from a small value near the ends of the machine to a large value near the middle of the machine, trapping plasma by centrifugal force; 7) the strength of the magnetic field is engineered to increase from a value near zero near the ends to a maximum value of 1 to several Tesla near the middle of the machine; and 8) conversion of plasma heat to rotation occurs by the Coriolis effect as plasma moves along the open field lines and either escapes or cools near the small radius regions at the ends of the machine. Another key feature is the use of static magnetic perturbations to induce waves in the plasma. The plasma rotation converts these static fields into plasma waves which are used to drive plasma currents or to accelerate particles to produce the desired beam.

The various embodiments differ in the detailed process by which they convert plasma thermal energy to mechanical energy of rotation and how they subsequently convert this rotational energy to beam energy. A preferred embodiment operates the heat engine in a continuous manner, similar to a gas or steam turbine heat engine. In this case, centrifugally confined plasma slowly leaks along the field and escapes the ends by a process similar to evaporation. Because collisions of particles are relatively rare, the axially lost plasma has a very low temperature compared with the confined plasma. Hence, most of the plasma thermal energy is converted to rotational energy. A second condition which is required for this energy conversion is to reduce the magnetic field along the length of the field line, so that it reaches a value close to zero at the ends of the machine. In this way, particle thermal energy causing motion perpendicular to the magnetic field is extracted to energy of motion parallel to the magnetic field and efficient conversion to mechanical energy is accomplished.

In a second preferred embodiment, similar to a conventional piston heat engine, plasma oscillations are driven to cause cyclic compression and expansion of two plasma masses in an adiabatic manner. These masses then collide with sufficient beam energy to cause desired fusion reactions. An important feature is to arrange the oscillation frequency to be ½ the rotation frequency so that the configuration is stationary when viewed in the frame of the not rotating machine. In this way, losses associated with externally fluctuating magnetic fields are eliminated.

While the invention is primarily associated with this arrangement and the subsequent behavior of the open-field-line plasma, advantages accrue if these open field lines surround a closed magnetic field region, forming a Field-Reversed Configuration. The Field-Reversed Configuration has been described in previous literature and patents, and beam-target operation has also been disclosed there, but no provision for the recapture of plasma heat to rotational energy has been previously described, limiting the efficacy for fusion applications. An additional advantage of a rotating Field-Reversed Configuration is the possibility to drive and sustain the required plasma current by applying static magnetic fields which create such waves relative to the rotating plasma as are know to be efficient in producing plasma current.

Conversion of rotational energy to beam energy is accomplished with high efficiency in one of several embodiments. In one embodiment, a beam is produced by electrostatic acceleration of injected fusion fuel. Clusters of fusion fuel atoms of an appropriate mass are given an appropriate electrical charge. The rapid rotation of the configuration implies that interior field lines are positively charged to a potential of one to several mega-Volts with respect to the electrically grounded external enclosure. This potential accelerates negatively charged fuel clusters into the interior field region. Because the injected clusters cross a magnetic field, the increase of their kinetic energy is directed into the toroidal direction around the system axis. Since the confined plasma is concentrated at large radius from this axis, it is so arranged that injected clusters pass through a tenuous plasma and arrive at a dense central plasma. In the dense plasma, they are rapidly ionized by collisions with the plasma particles and the separated ions and electrons are confined by the magnetic field so that the ions form the required beam.

In a second embodiment, an appropriate beam is formed by radio-frequency waves injected into the plasma. In the manner aforementioned, these waves are produced by a stationary, non-symmetric external magnetic field which the rotating plasma converts to a traveling wave. This wave travels across the plasma and resonates with the desired beam particles, accelerating them to the desired high energy of toroidal rotation.

As both the conversion of plasma thermal energy to rotation and the conversion of rotation to beam energy are accomplished with nearly 100% efficiency, it is required only to replace the small deficiency of recovered beam heating power, rather than the entire beam heating power. This is done by providing electrical power through the electrode system. Alternatively, the fusion gain may be sufficient so that fusion energy release heats the plasma and drives rotation to a degree greater than is required to sustain a constant rotation rate. In this case, electrical energy may be extracted directly through the electrode system and no thermal conversion of fusion energy release is required.

### DETAILED DESCRIPTION OF THE DRAWINGS

FIG. 1A: Magnetic field configuration for continuous plasma embodiment.

FIG. 1B: Continuous plasma embodiment of the invention.

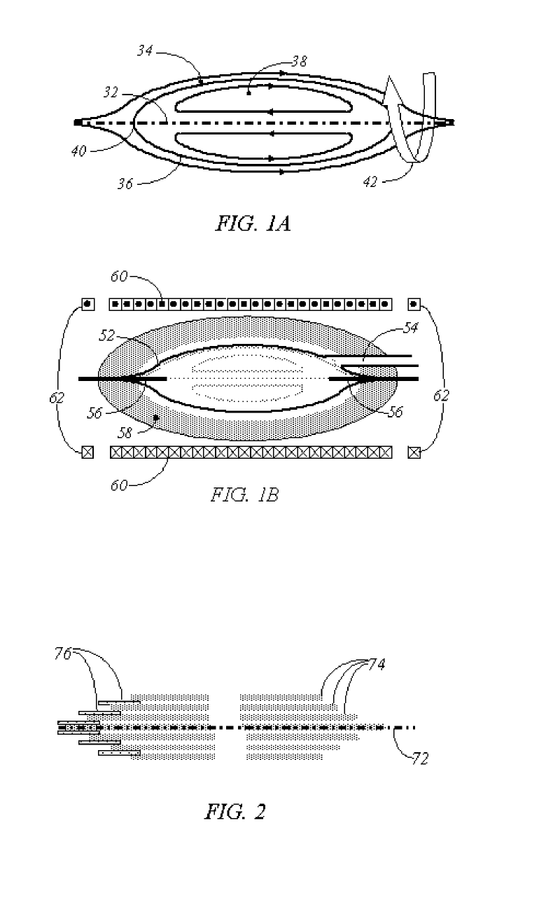

FIG. 2: End limiter construction method.

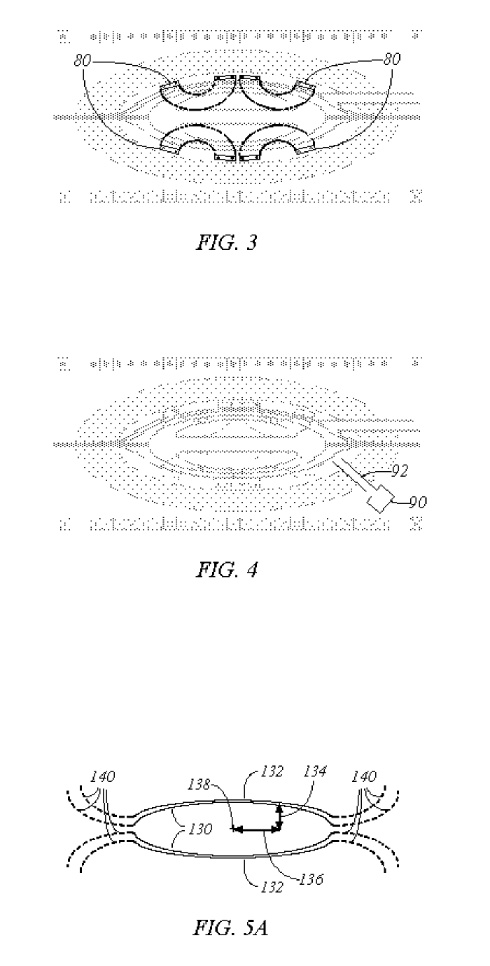

FIG. 3: Saddle coil configuration for inducing plasma current.

FIG. 4: Injector for forming beam within plasma.

FIG. 5A: Magnetic field configuration for oscillating plasma embodiment.

FIG. 5B: Oscillating plasma embodiment of the invention.

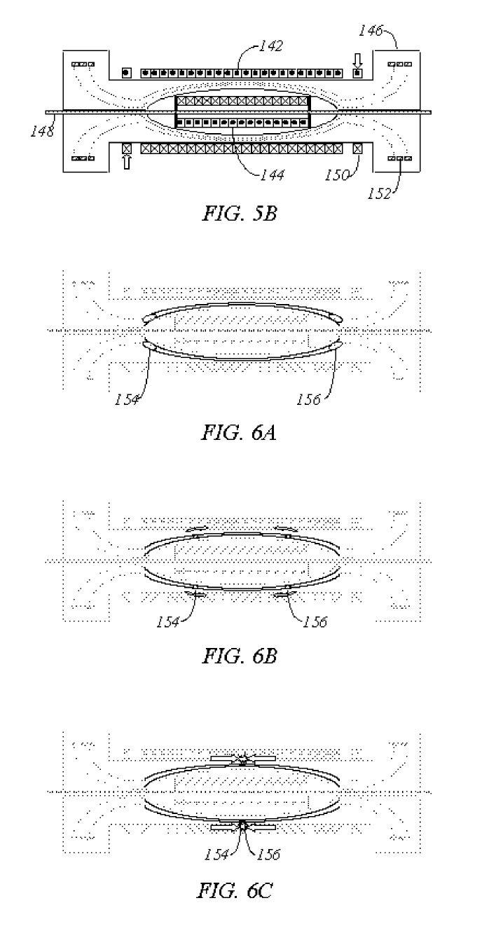

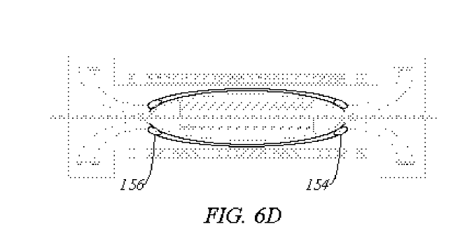

FIG. 6A: Operational scheme of the oscillating plasma embodiment, showing plasma masses at rest at ends of machine.

FIG. 6B: Operational scheme of the oscillating plasma embodiment, showing plasma masses accelerated toward each other.

FIG. 6C: Operational scheme of the oscillating plasma embodiment, showing central collision of plasma masses.

FIG. 6D: Operational scheme of the oscillating plasma embodiment, showing plasma masses returned to rest at ends of machine.

### DETAILED DESCRIPTION OF THE INVENTION

A first preferred embodiment accomplishes a heat engine cycle in a continuous plasma state. The required open field line magnetic configuration is produced by a field-reversed configuration. The magnetic configuration for this case is as shown in FIG. 1A. Since the entire system is rotationally symmetric, arrangement and operation is shown entirely by sections which correspond to cuts through a plane that contains the system axis. The axis of symmetry 32 forms the centerline of the system. An open field region 34 is separated from a closed field region 38 by the separatrix 36. The open field lines of interest are those which pass very close to the axis near points 40 on the axis at either end of the configuration where the magnetic field vanishes (spindle cusp points). The direction of the magnetic field is indicated along various field lines, while the direction of rotation is shown by the heavy arrow 42. Open-field-line plasma is continuously confined by centrifugal force, with the rotation driven by application of electrical potentials at the end of the field lines, as shown in FIG. 1B, where other machine details are also given.

Conditions are such that collisions of particles occur only rarely, so that a typical particle executes an axial oscillation along the field line several times before its motion is affected by a collision with another particle. For example, for deuterium-tritium operation, a plasma temperature of 500 electron-Volts (5,800,000 degrees Kelvin) is chosen. Plasma pressure in the open field region is near one atmosphere, giving a density of approximately 6.3×10²⁰ particles/cubic meter. Under such conditions, the mean-free-path for particle motion is approximately 6 meters, so that a typical particle makes several to many (depending on its exact energy) oscillations along the field line before its motion is affected by collisions with other particles. Under such conditions, particles gain energy in small (compared with the total energy which the well may confine) increments and are lost only after many such energy changing events. In this way, the excess energy over the limiting energy which the well may contain is very small, since it represents only the energy gained in a single transit along the field line. This effect has been observed in previous computer calculations and leads to a low exhaust temperature for particles lost along the field near the axis. It is important also that this open field region passes very close to a null of the magnetic field and that it passes very close to the axis. The former condition causes the thermal energy perpendicular to the magnetic field to be converted to motion parallel to the field, while the latter condition implies that very little rotational energy is carried out by loss of such particles.

As shown in FIG. 1B, the magnetic field configuration which confines the plasma is surrounded by a close fitting vacuum enclosure 52, which is evacuated through attached duct(s) 54 by an ultrahigh vacuum system (not shown). The open field line plasma is defined by two plasma limiters 56, which also provide the required electrical potentials to control the rotation of the open field plasma (more details of these assemblies are shown in FIG. 2). If the fusion fuel cycle chosen for operation produces neutrons, a blanket 58 surrounds the entire plasma-containing vessel and absorbs these neutrons. Energy so deposited there is removed by a steam or high temperature gas cooling system and is used to drive a set of turbines which can generate electricity, for example (heat exchange system, turbines, generators, etc. not shown). In case the design uses an aneutronic fuel cycle, such as proton-Boron-11, no such blanket is required, as all fusion products are magnetically confined within the vessel. The magnetic field is produced by a combination of an external solenoid 60 and a large plasma current. The direction of the solenoid current is as indicated, out of the plane of FIG. 1B at the top and into the plane at the bottom. Additional solenoid coils 62 are included at either end for the control of the axial position of the plasma. These coils produce corrections to the main solenoid field by feedback to maintain axial centering of the configuration.

The plasma limiters are so constructed so that the open magnetic field passes through their bounding surface. In addition, portions of the limiters which intersect distinct field line regions are electrically insulated from one another so that an electric field which is oriented perpendicular to the magnetic field is produced. This well known method for inducing and controlling plasma rotation can be understood in the simplest terms by neglecting electrical potential variation along the magnetic field. (For supersonic rotation velocities, this is a good approximation.) Then each distinct field line acts as a “wire” and transmits the potential applied at its end its entire length. Placing a voltage difference at the field line ends then produces an electric field across the magnetic field and induces plasma rotation in a manner similar to a synchronously rotating DC electric motor.

If the maximum magnetic field is less than 2 Tesla, magnetically soft iron can be used to accumulate the open field line magnetic flux and carry it axially along the limiter structure. A design appropriate for a neutronic fuel cycle is shown in FIG. 2. The axis of the system 72 is shown again for reference. Because of the length of the actual structure, the drawing is not to scale, and a portion of the length in the center of the drawing is not shown. FIG. 2 illustrates the left-hand limiter, as shown in FIG. 1B. The structure consists of a series of coaxial cylinders 74 made of magnetically soft iron. Each of these cylinders is insulated from the others by insulating cylinders 76 at the end away from the plasma region, and is cantilevered from this end to the free end which intersects the plasma. This design removes the insulators from contact with the plasma and from most of the neutron flux, assuring a long operating life and minimizing the possibility of surface flashover. In operation, magnetic field lines intersect the tips of the cylinders 74 and the associated flux is trapped in the iron and passes axially along the structure. Plasma follows these field lines to the cylinders and is extinguished there by contact with the material. To maintain vacuum quality, a coating of a refractory material may be placed in these tip regions.

The total voltage applied to the open field region through the limiters ranges from several kilo-Volts to over 100 kilo-Volts, depending on the design details. The inner cylinders are electrically positive relative to the outer cylinders. An external DC power supply energizes the various cylinders of the limiters. Alternatively, the charged fusion products can deposit their energy as heat in the closed field line plasma. This heat is converted to rotational energy as previously described. The rotational drive exceeds other losses, for example the energy required for beam acceleration, which is described subsequently. This excess rotational energy can then be extracted directly as electricity through the limiters, in which case the plasma acts as a homopolar generator. An appropriate design with aneutronic fuel can completely eliminate the requirement for any additional external heat exchangers, turbines, generators, etc., providing a very compact and efficient system.

The description of this embodiment is completed by describing means for inducing and maintaining plasma current and for injection of fuel gas and beam particles. Plasma current is driven by the rotating magnetic field method, which is known from the literature [Hoffman, A. L. et al., 13 Phys. Plasmas 012507 (2006)]. In contrast to previous designs which require a high power radio frequency power supply to produce a rotating magnetic field, the present invention uses a static magnetic dipole field. Plasma rotation then causes this static field to appear to the plasma as a rotating dipole field and plasma current is driven exactly as in the systems described in the literature. The static dipole is oriented transverse to the system axis and is produced by four saddle-shaped coils 80 positioned at the top and bottom of the vacuum chamber, as shown in FIG. 3. The currents in these coils are steady and in the directions indicated in FIG. 3, so as to produce a dipole field which is vertically upward in the left hand half of the machine and vertically downward in the right hand half. The strength of these dipole components is small compared to the main magnetic field, less than 0.01 Tesla.

Fueling is accomplished by feeding gas into the chamber through the end limiters, providing a source of particles on the axis of the machine. In this embodiment, a beam is produced in the configuration by injection of fuel which is electrically charged. This injection also occurs near the axis of the machine. Because of centrifugal force, the plasma density is very peaked away from the axis, so that there is only a tenuous plasma near the axis. However, there is a large electric field and associated potential near the axis. This potential is generated by plasma rotation in the manner of a homopolar generator, and can cause the innermost closed field lines to charge to over 1 mega-Volt positive relative to the axis. A proper choice of total mass and total electrical charge on the injected beam particles will cause them to be accelerated into the innermost closed field region and form a beam of the desired energy there, as they collide with the dense plasma and become ionized. Beam particles are formed in source(s) 90 and accelerated electrostatically to a low energy, then transported through duct(s) 92 as shown in FIG. 4.

Many variations of the continuous plasma embodiment are possible. For example, the closed-field-line plasma may be replaced by an internal solenoid (similar to that shown in FIG. 5A), the current of which then forms the same open-field-line configuration as shown in FIG. 1A. Such an internal solenoid can be supported by the plasma limiters and surrounded by a vacuum-tight enclosure. Alternative beam formation techniques may also be used. For example, waves may be generated in the plasma by static magnetic perturbations. Magnetically soft iron bars which are parallel to the main axis and located periodically around the circumference of the machine can produce a magnetic perturbation with a desired structure, so that a wave of a specified frequency is produced by the plasma rotation. Such waves then propagate across the plasma and resonate with desired beam particles, accelerating them to the desired high energy. Finally, it is possible to rotate the plasma at a high rate, so that its speed is the speed of the desired beam. Low-energy particles can then be introduced as charge neutral gas or pellets. When these encounter the plasma, they form the desired beam by their relative motion to the rapidly rotating plasma.

Oscillating embodiments of the invention also exist. Operation is shown in the drawings. The portion of the inner field lines 130 and outer field lines 132 which are shown as solid curves have a special shape. This shape is determined by two conditions. First the average field line (midway between these two limits) follows a particular curve defining the center of the annular region shown, so that the radius 134 R from the cylindrical axis and the axial distance 136 Z from the center 138 are almost as given by the formula Z/R_{M}=aE(u,k)−F(u,k)/a, where R_{M} is the maximum radius of the average at the center of the machine, a=5 is an adjustable parameter, the angle u is determined by sin u=(1−R²/R_{M}²)^{1/2}/k, k is given by k=(1−1/a²)^{1/2}, and E and F are the Jacobi elliptic functions of the second and first kind, respectively. Secondly, the separation of the inner and outer field lines is such that the magnetic field strength B varies nearly according to B/B_{M}=[1+(R_{T}−1)(1−R²/R_{M}²)/k²]⁻¹, where B_{M} is the maximum field strength at the middle of the field line, and R_{T} is the temperature ratio (say R_{T}=20). The portion of the field lines shown as dashed curves 140 in FIG. 5A may be chosen for convenience of access, as the accelerated plasma does not reach this portion of the field.

The magnetic field of FIG. 5A is produced by external 142 and internal 144 solenoids, as shown in FIG. 5B. These coils are located outside of a vacuum vessel 146, which surrounds the plasma region. The internal solenoid 144 is supported by a center post 148, which also supplies the electrical power and cooling required for the solenoid. Additional coils 150 are used to shape the field in the end regions and to provide drive for oscillation of the plasma masses, as described subsequently. Plasma rotation is induced and maintained by electrode sets 152 located inside the vacuum vessel and powered by external voltages.

The operational sequence of plasma masses 154 and 156 accelerating and colliding is as shown in FIGS. 6A-6D. FIG. 6A shows the masses at the maximum expansion portion of the cycle, where they are located at a small radius near the ends of the machine. As they move down the potential well, they simultaneously gain velocity and compress and heat, as shown in FIG. 6B. At the maximum compression phase, they arrive at the center of the machine with a maximum translation velocity and collide, producing fusion reactions there, as shown in FIG. 6C. After passing through one another, they expand and slow as they reach the small radius position again, with the two masses reversed (FIG. 6D). The cycle then repeats, with fusion energy release with each central collision.

Charged particles produced in the fusion reactions are not confined in the machine, because of their high kinetic energy. The magnetic field configuration causes them to escape rapidly along the field lines and deposit their energy on the electrode structures 152 of FIG. 5B. Alternatively, these structures may be made grids, so that particles pass through them and deposit their energy on a heat exchanger which lies radially outside these structures. Finally, known direct conversion designs may be applied to these escaping particles, by placing the converters radially surrounding the grid electrodes. These details are known from prior art and are not further described here.

Other critical features of the oscillating design are the following: The control of the rotation profile across the plasma annulus. The rotation rate of each field line (which is constant along the field line) should be made constant near the center of the annulus, and decrease in a controlled manner toward the inner and outer radial limits of the annulus, so that there is no rotation of the limiting field lines. This is important to eliminate excessive electrical stress on the nearby vacuum chamber walls and to provide control of the background plasma density and temperature. A second critical detail is the means to maintain plasma masses in the configuration shown in FIG. 6. This is accomplished by first arranging that the axial bounce frequency of the plasma masses be ½ the rotation rate. This corresponds to a=5, where a is the aforementioned parameter. In this way the desired oscillating state appears stationary as seen from the non-rotating machine frame. The stationary field does not induce any currents in the external structures and thus avoids eddy current losses associated with such an effect. Additionally, the desired oscillations are resonant with a fixed magnetic field which is such as to increase the magnetic field near a single angle of azimuth at either end of the machine, with these azimuthal angles opposite at the two ends. This magnetic field shaping is accomplished by shifting some of the coils 150 so that their center is slightly displaced from the axis, with the shift in opposite directions at the two ends of the machine. This is indicated by the heavy arrows in FIG. 5B. A final detail is the closure of the heat engine cycle by removal of heat at the maximum expansion phase when the plasma masses are near the end of the field lines (FIG. 6A or 6D). Heat removal occurs by two mechanisms, radiation and evaporation. Radiation occurs when the plasma temperature drops sufficiently low that the plasma becomes only incompletely ionized. Evaporation occurs because the centrifugal well provided has only finite depth, and particles with sufficient total energy escape confinement over the top of the well. Both of these processes preferentially remove energy from the cool plasma at maximum expansion, completing the heat engine cycle.

The details of embodiment given here are not meant to limit possible embodiments. Any arrangement similar to those described here which employs magnetized plasma rotation and conversion of plasma heat to rotational energy is an alternate embodiment of the invention described here.

What is claimed is:

1. A method of inducing nuclear fusion reactions comprising the following steps:
Introducing a low-pressure gas into an evacuated enclosure,
Placing a magnetic field lying symmetrically within all planes containing the cylindrical axis of the system within said enclosure by energizing an external solenoid in combination with end limiter structures to which said magnetic field lines are connected,
Forming a rapidly rotating plasma by application of electrical potentials through said end limiters,
Inducing a large, axis encircling current in said rotating plasma, said current sufficient to cause the magnetic field to reverse along the axis, forming a field-reversed configuration,
Raising the temperature of said field-reversed configuration and surrounding open-field-line plasma to a value sufficient to allow beam-target operation,
Introducing an energetic beam of particles into the field-reversed configuration and/or the surrounding open-field-line plasma region, and
Arranging the open-field-line plasma so that a plasma heat engine results, which engine converts plasma thermal energy with efficiency over 90% to rotational energy.

2. The method of claim 1. in which the said circulating current is driven by the rotating-magnetic-field method using a stationary dipole field and plasma rotation.

3. The method of claim 1. in which the beam of particles is formed from electrostatic acceleration of low-energy fuel particles introduced from the plasma edge, said electrostatic acceleration occurring due to the large electrical potential induced by rapid rotation of the field-reversed configuration.

4. The method of claim 1. in which the beam of particles is formed by resonant acceleration of plasma particles using waves induced by static magnetic perturbations combined with plasma rotation.

5. The method of claim 1. in which the beam of particles is formed by collision of room temperature or cryogenic gas or solid particles with a plasma rotating at the desired beam velocity.

6. The method of claim 1. in which the field-reversed configuration is replaced by an internal solenoid, forming a similar open-field-line rapidly rotating plasma.

7. The method of claim 1. in which charged particles produced by fusion reactions are trapped within the plasma and produce additional plasma heating.

8. The method of claim 7. in which the additional plasma heating is converted to rotation with more than sufficient energy to maintain the plasma rotation.

9. The method of claim 8. in which the additional rotational energy is captured through the end limiter electrode system to produce electrical power.

10. A nuclear fusion reactor comprising:
Introducing a low-pressure gas into an evacuated enclosure,
The field and plasma configuration of claim 1. with optional features of claims 2-8. producing nuclear fusion reactions,
Known additional external systems required to maintain vacuum conditions, introduce fuel gas, and optionally capture released neutrons and convert said neutron energy to heat, and
Known external systems for the conversion of heat into electrical power.

11. An alternative method of inducing nuclear fusion reactions comprising the following steps:
Producing a special magnetic field configuration consisting of field lines lying symmetrically in all planes containing the cylindrical axis of the system,
Causing the central portion of each of said field lines to assume a carefully specified shape and magnetic field strength profile,
Causing said field lines to rotate rapidly by arranging that each line terminate on an electrode with a specified electrical voltage,
Placing a background plasma on said rotating field line configuration, and
Driving plasma mass oscillations by stationary magnetic perturbations produced by coils placed near end of central field line region.

12. The method of claim 11. which produces a nearly harmonic potential energy well for oscillation of plasma masses.

13. The method of claim 11. which induces a thermal cycle by harmonic plasma motion combined with magnetic field strength variation and radiation loss from expanded plasma masses.

14. The method of claim 11. which produces central collisions of oscillating plasma masses and induces fusion reactions.

15. The method of claim 11. which produces the background plasma by control of applied electrode potential and associated plasma rotation profile.

16. The method of claim 11. in which the oscillation frequency is ½ the rotational frequency, so that the magnetic and plasma configuration is stationary in the frame of the machine.

17. The thermal cycle of claim 13. which efficiently recovers collision energy dissipated as heat.

18. The method of claim 14. further including conventional means of capturing energy from said fusion reactions, to convert said energy to useful forms of power such as electricity.

19. The field configuration of claim 11, produced by a combination of internal and external solenoids carrying electrical current and additional end coils carrying electrical current:
An evacuated chamber containing the said field configuration,
A known system for inducing low pressure fusion fuel gas,
Known means of capturing fusion energy release in form of charged particles at ends of field lines, and
Known means of converting said captured energy to useful power, such as electricity.

20. Any additional variation of magnetic field and plasma arrangement which accomplishes a plasma heat engine using rapid rotation.

21. The application of the heat engine of claim 20. to beam-target nuclear fusion.

22. A nuclear fusion reactor based on the method of claim 20. and 21.
